(19) United States
(12) Patent Application Publication
(10) Pub. No.: US 2013/0147863 A1
(43) Pub. Date: Jun. 13, 2013

(54) METHOD OF DISPLAYING THREE-DIMENSIONAL STEREOSCOPIC IMAGE AND DISPLAY APPARATUS FOR PERFORMING THE SAME

(71) Applicants: Kwan-Ho KIM, Asan-si (KR); Kang-Min KIM, Seoul (KR); Seon-Ki KIM, Anyang-si (KR); Ah-Reum KIM, Cheonan-si (KR); Jae-Woo JUNG, Incheon (KR)

(72) Inventors: Kwan-Ho KIM, Asan-si (KR); Kang-Min KIM, Seoul (KR); Seon-Ki KIM, Anyang-si (KR); Ah-Reum KIM, Cheonan-si (KR); Jae-Woo JUNG, Incheon (KR)

(73) Assignee: SAMSUNG DISPLAY CO., LTD., Yongin-City (KR)

(21) Appl. No.: 13/542,047

(22) Filed: Jul. 5, 2012

(30) Foreign Application Priority Data
Dec. 13, 2011 (KR) 10-2011-0133661

(51) Int. Cl. G09G 3/36; G09G 5/10

(52) U.S. Cl. 345/691; 345/87

(57) ABSTRACT

A method of displaying a three-dimensional stereoscopic image includes providing a display panel with a data signal including a left-eye data signal and a right-eye data signal, sequentially providing each of a plurality of segment blocks of an active polarized panel with a driving signal including a high level and a low level, where the active polarized panel emits first polarized light in a first polarizing mode of the driving signal based on the data signal, and the active polarized panel emits second polarized light in a second polarizing mode of the driving signal based on the data signal, and selectively providing the display panel with light based on a level changing interval, during which a level of the driving signal is changed.

This application claims priority to Korean Patent Application No. 10-2011-0133661, filed on Dec. 13, 2011, and all the benefits accruing therefrom under 35 U.S.C. §119, the content of which in its entirety is herein incorporated by reference.

### BACKGROUND

1. Field

Exemplary embodiments of the invention relate to a method of displaying a three-dimensional stereoscopic image and a display apparatus for performing the method. More particularly, exemplary embodiments of the invention relate to a method of displaying a three-dimensional stereoscopic image with enhanced display quality and a display apparatus for performing the method.

2. Description of the Related Art

Generally, a liquid crystal display (“LCD”) apparatus displays a two-dimensional (“2D”) image. Recently, the display apparatus for displaying a three-dimensional (“3D”) stereoscopic image has been developed, as demands for the 3D stereoscopic image have been increased in the industrial fields such as games and movies, for example.

Generally, the display apparatus displays the 3D stereoscopic image using a principle of binocular parallax through two eyes of a human. In the binocular parallax, as two eyes of the human are spaced apart from each other, images viewed at the different angles are inputted to the brain of the human and are combined in the brain. Thus, the stereoscopic image may be perceived by the brain.

The stereoscopic image display apparatus is typically classified into a stereoscopic type with a separate spectacle and an auto-stereoscopic type without the separate spectacle. The stereoscopic type includes a passive polarized glasses type using a pair of glasses having different polarized filters, corresponding to two eyes, respectively, and an active shutter glasses type, in which a left-eye image and a right-eye image are time-divided to be periodically displayed, and the viewer wears a pair of glasses which sequentially open or close a left-eye shutter and a right-eye shutter, synchronized with the periods of the left and right-eye images, respectively.

However, in the display apparatus for displaying the 3D stereoscopic image applying the polarized glasses type or the shutter glasses type, a display defect, such as crosstalk, flicker and vertical and horizontal lines, for example, may occur.

### SUMMARY

Exemplary embodiments of the invention provide a method for displaying a three-dimensional stereoscopic image, in which a crosstalk and a brightness difference are effectively prevented.

Exemplary embodiments of the invention also provide a display apparatus for performing the method.

According to an exemplary embodiment, a method of displaying a three-dimensional stereoscopic image includes providing a display panel with a data signal including a left-eye data signal and a right-eye data signal, sequentially providing each of a plurality of segment blocks of an active polarized panel with a driving signal including a high level and a low level, where the active polarized panel emits first polarized light in a first polarizing mode of the driving signal based on the data signal, and the active polarized panel emits second polarized light in a second polarizing mode of the driving signal based on the data signal, and selectively providing the display panel with light based on a level changing interval, during which a level of the driving signal is changed.

In an exemplary embodiment, a first light blocking period, during which the light to the display panel is blocked, may include a rising interval and a falling interval, the level of the driving signal is changed from the low level into the high level during the rising interval of the first light blocking period, and the level of the driving signal is changed from the high level into the low level during the falling interval of the first light blocking period.

In an exemplary embodiment, the active polarized panel may include a polarizing liquid crystal layer, and the first light blocking period of the display panel may be preset based on a response rate of the polarizing liquid crystal layer.

In an exemplary embodiment, the first light blocking period may include a mixed interval, and the first and second polarizing modes may be changed from one to the other during the mixed interval.

In an exemplary embodiment, the selectively providing the display panel with the light may include sequentially providing a plurality of display blocks of the display panel with the light from a plurality of light emitting blocks, where the display blocks correspond to the segment blocks, and blocking the light from each of the light emitting blocks to a corresponding display block of based on a change of the level of the driving signal applied to a corresponding segment block of the corresponding display block.

In an exemplary embodiment, the light emitting blocks may be in one-to-one correspondence with the segment blocks.

In an exemplary embodiment, each of the light emitting blocks may correspond to at least two adjacent segment blocks of the segment blocks.

In an exemplary embodiment, a second light blocking period, during which the light to at least one of the display blocks is blocked, may include a rising interval and a falling interval, the level of the driving signal applied to the segment blocks corresponding to the at least one of the display blocks may be changed from the low level into the high level during the rising interval of the second light blocking period, and the level of the driving signal applied to the segment blocks corresponding to the at least one of the display blocks may be changed from the low level into the low level during the falling interval of the second light blocking period.

In an exemplary embodiment, the display panel may include a displaying liquid crystal layer, the active polarized panel may include a polarizing liquid crystal layer, and the second light blocking period of the display block may be preset based on response rates of the displaying liquid crystal layer and the polarizing liquid crystal layer.

In an exemplary embodiment, the second light blocking period may include a first mixed interval and a second mixed interval, the left-eye data and the right-eye data may be changed from one to the other during the first mixed interval, and the first and second polarizing modes may be changed from one to the other during the second mixed interval.

According to an exemplary embodiment, a display apparatus includes a display driving part which provides a display panel with a data signal including a left-eye data signal and a right-eye data signal, an active polarized panel including a plurality of segment blocks, where the active polarized panel emits first polarized light in a first polarizing mode and emits second polarized light in a second polarizing mode, a polarized light driving part which sequentially provides each of the segment blocks with a driving signal, where a level of the driving signal includes a high level and a low level, the active polarized panel is in the first polarizing mode based on the high level of the driving signal in the first polarizing mode, the active polarized panel is in the second polarizing mode based on the low level of the driving signal, and a light source part which selectively provides the display panel with light based on a change of the level of the driving signal.

In an exemplary embodiment, the light source part may block the light to the display panel based on a rising interval and a falling interval, where the level of the driving signal may be changed from the low level into the high level during the rising interval, and the level of the driving signal may be changed from the high level into the low level during the falling interval.

In an exemplary embodiment, the active polarized panel may include a polarizing liquid crystal layer, and a first light blocking period, during which a light to the display panel is blocked, may be preset based on a response rate of the polarizing liquid crystal layer.

In an exemplary embodiment, the first light blocking period may include a mixed interval, and the first and second polarizing modes may be changed from one to the other during the mixed interval.

In an exemplary embodiment, the light source part may include a plurality of light emitting blocks which sequentially provides a plurality of display blocks of the display panel with the light, the display blocks may correspond to the segment blocks, and the light to each of the display blocks may be blocked based on the change of the level of the driving signal applied to a corresponding segment block thereof.

In an exemplary embodiment, the light emitting blocks may be in one-to-one correspondence with the segment blocks.

In an exemplary embodiment, each of the light emitting blocks may correspond to at least two adjacent segment blocks of the segment blocks.

In an exemplary embodiment, a second light blocking period, during which the light to at least one of the display blocks is blocked, may include a rising interval and a falling interval, the level of the driving signal applied to the segment blocks corresponding to the at least one of the display blocks may be changed from the low level into the high level during the rising interval of the second light blocking period, and the level of the driving signal applied to the segment blocks corresponding to at least one of the display blocks may be changed from the high level into the low level during the falling interval of the second light blocking period.

In an exemplary embodiment, the display panel may include a displaying liquid crystal layer, and the active polarized panel comprises a polarizing liquid crystal layer, and the second light blocking period of the display block may be preset based on response rates of the displaying liquid crystal layer and the polarizing liquid crystal layer.

In an exemplary embodiment, the second light blocking period may include a first mixed interval and a second mixed interval, the left-eye data and right-eye data may be changed from one to the other during the first mixed interval, and the first and second polarizing modes may be changed from one to the other during a second mixed interval.

According to an exemplary embodiment, light emitting source part is controlled based on change of a level of a driving signal driving a segment block. The segment block may operate in a first polarizing mode and a second polarizing mode. In such an embodiment, a brightness difference perceived in the segment block may be enhanced, and a brightness ratio of a three-dimensional stereoscopic image to a two-dimensional image may be enhanced.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus according to the invention;

FIG. 2 is a signal timing diagram of driving signals illustrating an exemplary embodiment of a method of displaying a three-dimensional stereoscopic image for the display apparatus of FIG. 1;

FIG. 3 is a waveform diagram illustrating an exemplary embodiment of data signals applied to a display panel and a driving signal applied to an active polarized panel of FIG. 1, showing brightness thereof;

FIG. 4 is a block diagram illustrating an alternative exemplary embodiment of a display apparatus according to the invention;

FIG. 5 is a signal timing of driving signals illustrating an exemplary embodiment of a method of displaying a three-dimensional stereoscopic image for the display apparatus of FIG. 4; and

FIG. 6 is a signal timing diagram of driving signals illustrating an alternative exemplary embodiment of a method of displaying a three-dimensional stereoscopic image according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be explained in detail with reference to the accompanying drawings.

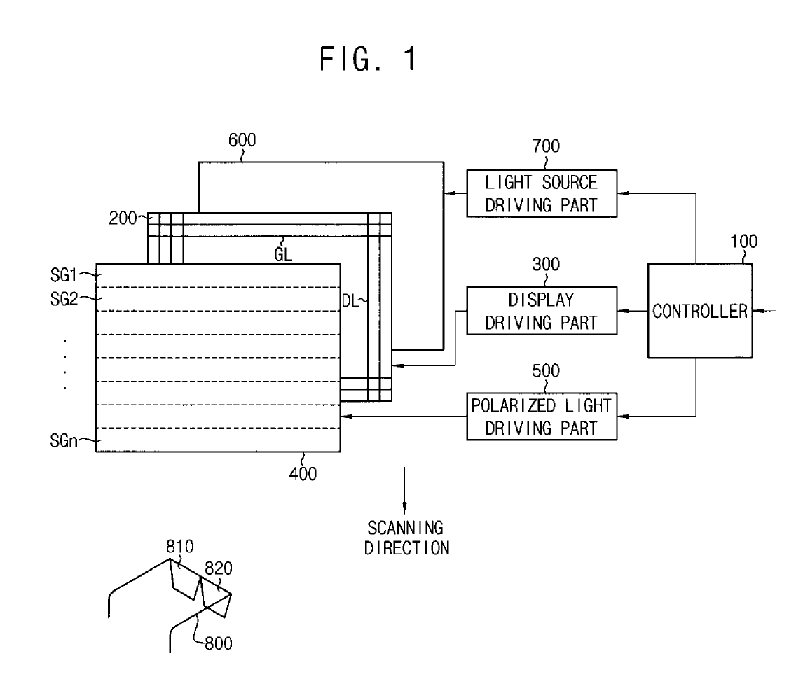

FIG. 1 is a block diagram illustrating an exemplary embodiment of a display apparatus according to the invention.

Referring to FIG. 1, the display apparatus including a controller 100, a display panel 200, a display driving part 300, an active polarized panel 400, a polarized light driving part 500, a light emitting source part 600, a light source driving part 700 and polarized glasses 800.

The controller 100 receives a two-dimensional image data and a three-dimensional stereoscopic image data. The controller 100 controls operations of elements of the display apparatus in a two-dimensional image mode or in a three-dimensional stereoscopic image mode based on the received image data.

The display panel 200 includes a plurality of data lines DL, a plurality of gate lines GL, and a plurality of sub pixels. The sub pixels may be arranged substantially in a matrix shape including a plurality of pixel rows and a plurality of pixel columns. At least one of the sub pixels may include a switching element and a pixel electrode. The switching element is electrically connected to a corresponding data line of the data lines and a corresponding gate line of the gate lines. The pixel electrode is electrically connected to the switching element. In an exemplary embodiment, the display panel 200 may include a first display substrate, a second display substrate and a displaying liquid crystal layer. The switching element and the pixel electrode may be provided on the first display substrate. The second display substrate may be opposite to, e.g., face, the first display substrate and include a common electrode. The displaying liquid crystal layer is disposed between the first and second display substrates.

The display driving part 300 drives the display panel 200 based on a control of the controller 100. The display driving part 300 may include a data driving part and a gate driving part. The data driving part drives data lines, and the gate driving part drives gate lines.

The active polarized panel 400 includes a plurality of segment blocks, e.g., a first to n-th segment blocks SG1 to SGn. The segment blocks are aligned along a scanning direction. In an exemplary embodiment, the active polarized panel 400 may include a first polarized substrate, a second polarized substrate and a polarizing liquid crystal layer. A segment electrode may be provided on the first polarized substrate. The second polarized substrate may be opposite to the first polarized substrate, and include an opposing electrode. The opposing electrode may be opposite to the segment electrode. The polarizing liquid crystal layer is disposed between the first and second polarized substrates. The polarizing liquid crystal layer may be in an optically compensated band (“OCB”) mode. A high voltage or a low voltage may be applied to the segment electrode based on a polarizing mode. A low voltage is applied to the opposing electrode. The low voltage is may have a ground potential. The active polarized panel 400 is driven based on a segment-block-by-segment-block basis. The segment electrode may be provided on each of the segment blocks. Hereinafter, an exemplary embodiment of an active polarized panel 400 including a first to eight segment blocks SG1 to SG8 will be described for convenience of description, but the invention is not being limited thereto. In an alternative exemplary embodiment, the active polarized panel may include various numbers of segment blocks.

The polarized light driving part 500 drives the active polarized panel 400 based on the image mode under control of the controller 100.

In an exemplary embodiment, in the three-dimensional stereoscopic image mode, the low voltage is applied to the opposing electrode of the active polarized panel 400, and the high voltage is sequentially applied to the segment electrodes of the active polarized panel 400 along a direction during a first frame. A left-eye image is scanned in the direction. The left-eye image is displayed in the first frame. In such an embodiment, the active polarized panel 400 is configured to emit first polarized light using light emitted from the display panel 200 in a first polarizing mode. In an exemplary embodiment, in the three-dimensional stereoscopic image mode, the low voltage may be applied to the opposing electrode and the low voltage may be sequentially applied to the segment electrodes during a second frame. The right-eye image is displayed in the second frame. In such an embodiment, the active polarized panel 400 is configured to emit second polarized light using light emitted from the display panel 200 in a second polarizing mode.

In an exemplary embodiment, in the two-dimensional image mode, the low voltage may be applied to the opposing electrode, and the low voltage may be sequentially applied to the segment electrodes. In such an embodiment, the active polarized panel 400 may operate in the second polarizing mode in the two-dimensional image mode. The viewer may not wear the polarized glasses 800 in the two-dimensional image mode, such that the viewer may not perceive the second polarized light emitted from the active polarized panel 400, and the viewer thereby perceives the two-dimensional image, which is a planar image.

The light source part 600 generates light and provides the display panel 200 with the light. In an exemplary embodiment, the light source part 600 may include a light guide plate and at least one of light sources disposed on at least one edge of the light guide plate. In an alternative exemplary embodiment, the light source part 600 may include at least one light source disposed under the display panel 200 without the light guide plate. In an exemplary embodiment, the light source may be a lamp or a light emitting diode, for example, but not being limited thereto.

The light source driving part 700 drives the light source part 600 based on the control of the controller 100. In an exemplary embodiment, the controller 100 controls a light source driving signal applied to the light source part 600 based on a rising interval and a falling interval of the voltages applied to the segment electrodes. In an exemplary embodiment, the light source driving signal may be synchronized with the rising interval and the falling interval of the voltages applied to the segment electrodes. In such an embodiment, a voltage applied to each of the segment electrodes is changed from a high level to a low level during the rising interval, and the voltage is changed from the low level to the high level during the falling interval.

The light source 600 generates the light in response to the light source driving signal having the high level, and does not generate the light in response to the light source driving signal having the low level. Luminance uniformity of the light in each segment block may be deteriorated during the rising interval and the falling interval. In an exemplary embodiment, the display panel 200 does not receive the light from the light source 600 during the rising interval and the falling interval, such that a viewer may not perceive the brightness difference of the segment blocks, and display quality of a three-dimensional stereoscopic image is thereby substantially improved.

The polarized glasses 800 include a left-eye glass lens 810 and a right-eye glass lens 820. In an exemplary embodiment, in the three-dimensional stereoscopic image mode, the left-eye glass lens 810 allows first polarized light corresponding to a left-eye image to pass therethrough, and blocks second polarized light corresponding to a right-eye image. The active polarized panel 400 emits the left-eye image and the right-eye image. In an exemplary embodiment, in the three-dimensional stereoscopic image mode, the right-eye glass lens 820 may allow the second polarized light corresponding to the right-eye image to pass therethrough, and blocks the first polarized light corresponding to the left-eye image. In such an embodiment, the viewer perceives the three-dimensional stereoscopic image through the polarized glasses 800.

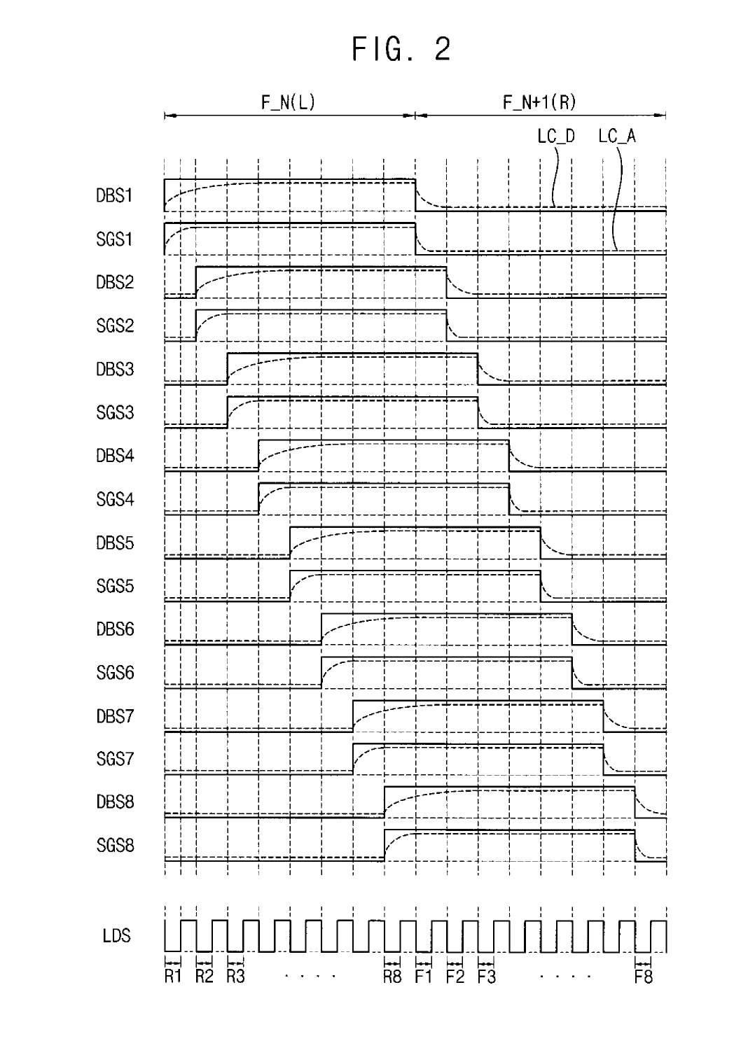

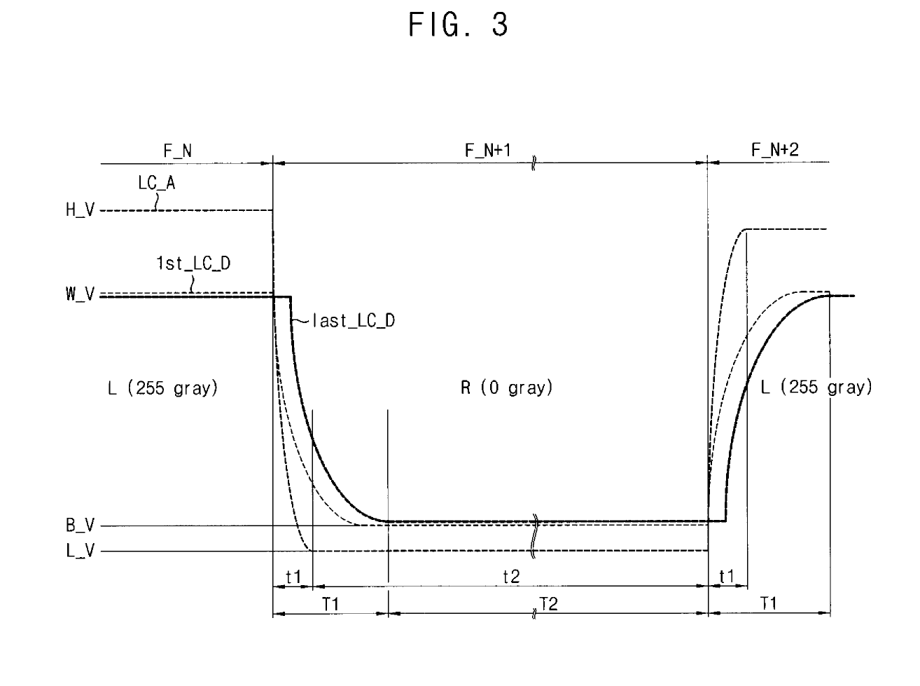

FIG. 2 is a signal timing diagram of driving signals illustrating an exemplary embodiment of a method of displaying a three-dimensional stereoscopic image for the display apparatus of FIG. 1. FIG. 3 is a waveform diagram illustrating an exemplary embodiment of data signals applied to a display panel and a driving signal applied to an active polarized panel of FIG. 1, showing brightness thereof.

Referring to FIGS. 1 and 2, the display driving part 300 provides the display panel 200 with a data signal corresponding to a three-dimensional stereoscopic image. In an exemplary embodiment, the display driving part 300 provides the display panel 200 with a left-eye data signal L during a N-th frame (F_N), and provides the display panel 200 with a right-eye data signal R during a N+1-th frame (F_N+1). Hereinafter, for convenience of description, an exemplary embodiment, where the left-eye data signal L is a data signal corresponding to a white grayscale, and the right-eye data signal R is a data signal corresponding to a black grayscale, will be described.

The display driving part 300 provides the display panel 200 with a data signal as a unit of a horizontal line along a scanning direction.

The display driving part 300 may sequentially provide first to eighth display blocks corresponding to first to eighth segment blocks with first to eighth data signals DBS1 to DBS8, respectively. Each of the first to eighth data signals DBS1 to DBS8 may be a data signal applied to a horizontal line of horizontal lines included in a corresponding display block

The polarized light driving part 500 provides the active polarized panel 400 with a driving signal. In an exemplary embodiment, the polarized light driving part 500 sequentially provide first to eighth segment electrodes of the active polarized panel 400 with first to eighth driving signals SGS1 to SGS8 having a high level, respectively, during the N-th frame F_N, in which the left-eye data signal L is applied to the display panel 200. In an exemplary embodiment, the polarized light driving part 500 sequentially provide the first to eighth segment electrodes of the active polarized panel 400 with the first to eighth driving signals SGS1 to SGS8 having a low level, respectively, during the N+1-th frame F_N+1, in which the right-eye data signal R is applied to the display panel 200. In such an embodiment, a low voltage is applied to an opposing electrode of the active polarized panel 400, which is opposite to the segment electrodes.

Referring to FIG. 3, a first liquid crystal response curve 1st_LC_D corresponds to a data signal applied to a first horizontal line of the first display block corresponding to the first segment block SG1. A second liquid crystal response curve last_LC_D corresponds to a data signal applied to a last horizontal line of the first display block. A third liquid crystal response curve LC_A corresponds to a driving signal applied to the first segment electrode of the active polarized panel 400.

The first and second liquid crystal response curves 1st_LC_D and last_LC_D are responsive curves of the displaying liquid crystal layer included in the display panel 200, and the third liquid crystal response curve LC_A is a responsive curve of the polarizing liquid crystal layer included in the active polarized panel 400.

A white voltage W_V of the left-eye data signal corresponding to a 255-th grayscale is applied to the first display block during the N-th frame F_N, a black voltage of the right-eye data signal corresponding to a 0-th grayscale is applied to the first display block during the N+1-th frame F_N+1, and a white voltage W_V of the left-eye data signal corresponding to a 255-th grayscale is applied to the first display block during a N+2-th frame F_N+2.

In an exemplary embodiment, as shown in the first and second liquid crystal response curves 1st_LC_D and last_LC_D of FIG. 3, a white voltage W_V of a previous frame, e.g., the N-th frame F_N, is changed to a black voltage B_V of a current frame, e.g., the N+1-th frame F_N+1, in the first display block, during a first display interval T1 of the current frame, which starts from a starting point of the current frame, e.g., the N+1-th frame F_N+1, and then the black voltage B_V is maintained during a second display interval T2 of the current frame after the first display interval T1. In such an embodiment, the black voltage B_V of the current frame, e.g., F_N+1, is changed to a white voltage W_V of a next frame, e.g., the N+2-th frame F_N+2, in the first display block, during a first display interval T1 of the next frame, which starts from a starting point of the next frame, e.g., the N+2-th frame F_N+2, and then the white voltage W_V is maintained during a second display interval T2 of the next frame after the first display interval T1.

In an exemplary embodiment, a driving signal of a high voltage H_V corresponding to the left-eye data signal L is applied to the first segment electrode during the N-th frame F_N, a driving signal of a low voltage L_V corresponding to the right-eye data signal R is applied to the first segment electrode during the N+1-th frame F_N+1, and the driving signal of the high voltage H_V corresponding to the left-eye data signal L is applied to the first segment electrode during the N+2-th frame F_N+2.

In an exemplary embodiment, as shown in the third liquid crystal response curve LC_A of FIG. 3, a high voltage H_V of the previous frame, e.g., the N-th frame F_N, is changed to a low voltage L_V of the current frame, e.g., the N+1-th frame F_N+1, in the first segment block, during a first polarizing interval t1, which starts from a starting point of the current frame, e.g., the N+1-th frame F_N+1, and then the low voltage L_V is maintained during a second polarizing interval t2 of the current frame after the first polarizing interval t1. In such an embodiment, the low voltage L_V of the current frame, e.g., the N+1-th frame F_N+1, is changed to a high voltage H_V of the next frame, e.g., the N+2-th frame F_N+2, in the first segment block, during a first polarizing interval t1 of the next frame, which starts from a starting point of the next frame, e.g., the N+2-th frame F_N+2, and then the high voltage H_V is maintained during a second polarizing interval t2 of the next frame.

In an exemplary embodiment, the first display block displays a mixed image, in which the left-eye and right-eye data signals are mixed with each other, during an earlier portion of the N+1-th frame F_N+1 (also referred to as a mixed interval), e.g., the first display interval T1 of the N+1-th Frame F_N+1. The first segment block changes from the first polarizing mode into the second polarizing mode during the first polarizing interval t1, such that an abnormal image, such as the mixed image displayed the first display block during the first polarizing interval t1, may be perceived.

When the abnormal image is displayed to the first display block corresponding to an upper portion or a bottom portion of the first segment block, and a normal image is displayed to the first display block corresponding to a middle portion between the upper portion and the bottom portion of the first segment block, viewer may perceive a brightness difference in each of the segment blocks.

In an exemplary embodiment, the light applied to the display panel 200 is blocked during the rising interval and the falling interval, in which a level of a driving signal applied to the segment electrode is changed, such that the viewer does not perceive the brightness difference in each of the segment blocks.

As shown in FIG. 2, the light source driving part 700 controls the light source driving signal LDS, which drive the light source part 600, corresponding to the rising interval and the falling interval of each of the first to eighth driving signals SGS1 to SGS8 to have a low level under the control of the controller 100.

In an exemplary embodiment, the light source driving signal LDS has a low level during a first rising interval R1, in which the first driving signal SGS1 applied to the first segment electrode corresponding to the first segment block is changed from the low voltage to the high voltage, and has the low voltage during a first falling interval F1, in which the first driving signal SGS1 is changed from the high voltage to the low voltage. In an exemplary embodiment, a light blocking period, in which the light applied to the display panel 200 is blocked, may correspond to the first rising interval R1 and the first falling interval F1. In an exemplary embodiment, an interval of the light blocking period corresponding to the first rising interval R1 and the first falling interval F1 may be determined based on a response rate of the polarizing liquid crystal layer, and may be longer than the first rising interval R1 and the first falling interval F1. In an exemplary embodiment, the light blocking period may include the first polarizing interval t1, in which the first segment block is operated in a mixed mode, in which the first and second polarizing modes are mixed with each other.

In an exemplary embodiment, the light source driving signal LDS has a low level during a second rising interval R2, in which the second driving signal SGS2 applied to the second segment electrode corresponding to the second segment block is changed from the low voltage to the high voltage, and has the low voltage during a second falling interval F2, in which the second driving signal SGS2 is changed from the high voltage to the low voltage. In an exemplary embodiment, the light blocking period may correspond to the second rising interval R2 and the second falling interval F2. In an exemplary embodiment, an interval of the light blocking period corresponding to the second rising interval R2 and the second falling interval F2 may be determined based on a response rate of the polarizing liquid crystal layer, and may be longer than the second rising interval R2 and the second falling interval F2. In an exemplary embodiment, the light blocking period may include the first polarizing interval t1, in which the second segment block is operated in the mixed mode, in which the first and second polarizing modes mixed with each other.

In an exemplary embodiment, the light source driving signal LDS has a low level during a third rising interval R3, in which the third driving signal SGS3 applied to the third segment electrode corresponding to the third segment block is changed from the low voltage to the high voltage, and has the low voltage during a third falling interval F3, in which the third driving signal SGS3 is changed from the high voltage to the low voltage. In an exemplary embodiment, the light blocking period may correspond to the third rising interval R3 and the third falling interval F3. In an exemplary embodiment, an interval of the light blocking period corresponding to the third rising interval R3 and the third falling interval F3 may be determined based on a response rate of the polarizing liquid crystal layer, and may be longer than the third rising interval R3 and the third falling interval F3. In an exemplary embodiment, the light blocking period may include the first polarizing interval t1, in which the third segment block is operated in a mixed mode, in which the first and second polarizing modes mixed with each other.

In such an embodiment, the light source driving signal LDS has a low level during a preset interval, in which a level of each of the first to eighth driving signals SGS1 to SGS8 is changed. In an exemplary embodiment, the rising interval and the falling interval may be determined based on the response rate of the polarizing liquid crystal layer of the active polarized panel 400.

In an exemplary embodiment, as the brightness difference of each of the segment blocks may occur during the rising interval and the falling interval, the light to the display panel 200 during the rising interval and the falling interval is blocked such that the viewer may not perceive the brightness difference of the segment blocks, and the display quality of a three-dimensional stereoscopic image is thereby substantially improved.

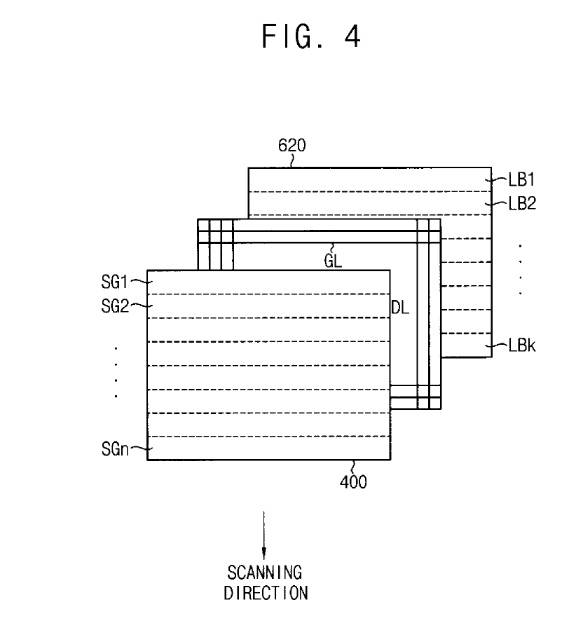

FIG. 4 is a block diagram illustrating an alternative exemplary embodiment of a display apparatus according to the invention.

The display apparatus in FIG. 4 is substantially same as the display apparatus shown in FIG. 1, except for a method of driving a light source part 620. The same or like elements shown in FIG. 4 have been labeled with the same reference characters as used above to describe the exemplary embodiments of the display apparatus shown in FIG. 1, and any repetitive detailed description thereof will hereinafter be omitted or simplified.

In an exemplary embodiment, the light source part 620 includes a plurality of light emitting blocks, e.g., first to k-th light emitting blocks LB1 to LBk, where ‘k’ is a natural number. The light emitting blocks LB1 to LBk are aligned along a scanning direction, and emit light sequentially along the scanning direction on a frame-by-frame basis.

The light emitting blocks LB1 to LBk may correspond the segment blocks, e.g., first to n-th segment blocks SG1 to SGn, respectively. In an exemplary embodiment, each of the light emitting blocks LB1 to LBk may correspond at least two segment blocks. In an exemplary embodiment, the light emitting blocks LB1 to LBk are synchronized with driving timings of the segment blocks SG1 to SGn, and the light emitting blocks LB1 to LBk may sequentially emit light to the segment blocks SG1 to SGn.

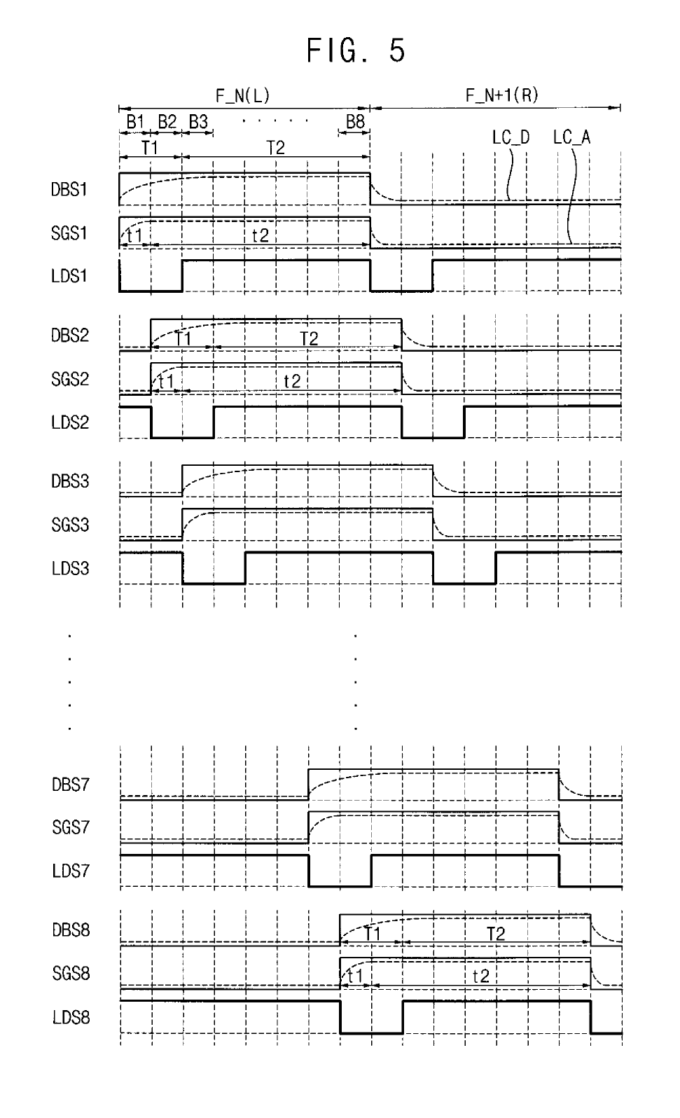

FIG. 5 is a signal timing diagram of driving signals illustrating an exemplary embodiment of a method of displaying a three-dimensional stereoscopic image for the display apparatus of FIG. 4.

Referring to FIGS. 1, 4 and 5, the display driving part 300 provides a first display block with a left-eye data signal L during a first block interval B1 of an N-th frame F_N, and provides the first display block with a right-eye data signal R during a first block interval B1 of an N+1-th frame F_N+1(e.g., the first data signal DBS1 in FIG. 5).

In an exemplary embodiment, the polarized light driving part 500 is synchronized with the display driving part 300, and the polarized light driving part 500 provides a segment electrode of the first segment block with a high-level voltage to drive the first segment block in a first polarizing mode corresponding to the left-eye data signal L during one frame from a first block interval B1 of the N-th frame F_N. In such an embodiment, the polarized light driving part 500 provides the segment electrode of the first segment block with a low-level voltage to drive the first segment block in a second polarizing mode corresponding to the right-eye data signal R during one frame from a first block interval B1 of the N+1-th frame F_N+1(e.g., the first driving signal SGS1 in FIG. 5).

In an exemplary embodiment, based on a displaying liquid crystal response curve LC_D, the first display block displays a mixed image, which is a transition image between an image of a previous frame and an image of a current frame, during a first display interval T1 of the current frame, and the first display block displays a left-eye image or a right-eye image during a second display interval T2 of the current frame. Based on a polarizing liquid crystal response curve LC_A, the first segment block operates in a mixed mode, in which a polarizing mode of the previous frame is changed to a polarizing mode of the current frame during a first polarizing interval t1 of the current frame, and the first segment block operates in a first polarizing mode or a second polarizing mode during a second polarizing interval t2 of the current frame.

The first display interval T1 and the first polarizing interval t1 overlap each other. In an exemplary embodiment, lengths of the first display interval T1 and the first polarizing interval t1 may be substantially the same as each other. In an alternative exemplary embodiment, the lengths of the first display interval T1 and the first polarizing interval t1 may be different from each other. In an exemplary embodiment, the lengths of the first display interval T1 and the first polarizing interval t1 may be determined based on responses of the displaying liquid crystal layer and the polarizing liquid crystal layer.

The light source driving part 700 generates a first light source driving signal LDS1 based on operating conditions of the first display block and the first segment block to selectively turn on the first light emitting block LB1 of the light source part 620 corresponding to the first segment block.

In an exemplary embodiment, the light blocking period, during which the light applied to the first display block is blocked, includes a rising interval and a falling interval of the first driving signal SGS1. In an exemplary embodiment, the light blocking period may correspond to the rising interval and the falling interval of the first driving signal SGS1. In an exemplary embodiment, an interval of the light blocking period corresponding to the rising interval and the third falling interval of the first driving signal SGS1 may be determined based on a response ratio of the polarizing liquid crystal layer and the displaying liquid crystal layer, and may be longer than the rising interval and the falling interval of the first driving signal SGS1. In an alternate exemplary embodiment, the light blocking period may include the first display interval T1 and the first polarizing interval t1.

In an exemplary embodiment, as shown in FIG. 5, the first light source driving signal LDS1 has a low level during the first display interval T1 including the first polarizing interval t1, and has a high level during the second display interval T2. The first light emitting block does not provide the first display block with light during the first display interval T1, and provides the first display block with the light during the second display interval T2.

In such an embodiment, the light is blocked to the first segment block during the rising interval and the falling interval of the first driving signal SGS1, during which a brightness difference of the first segment block may occur, such that a viewer may not perceive the brightness difference of the first segment block. In such an embodiment, the light is blocked to the first display block during the first display interval, in which the mixed image is displayed to the first display block, such that viewer may not perceive the mixed image, and the display quality of a three-dimensional stereoscopic image is thereby substantially improved.

The display driving part 300 provides a second display block with a left-eye data signal L during a second block interval B2 of the N-th frame F_N, and provides the second display block with a right-eye data signal R during a second block interval B2 of the N+1-th frame F_N+1 (e.g., the second data signal DBS2).

In an exemplary embodiment, the polarized light driving part 500 is synchronized with the display driving part 300, and the polarized light driving part 500 provides a high level voltage to a segment electrode of the second segment block during one frame from the second block interval B2 of the N-th frame F_N, and provides a low level voltage to the segment electrode of the second segment block during one frame from the second block interval B2 of the N+1-th frame F_N+1 (e.g., the second driving signal SGS2).

In such an embodiment, based on the displaying liquid crystal response curves LC_D, the second display block displays a mixed image, which is a transition image between an image of the previous frame and an image of the current frame, during the first display interval T1 of the frame, and the second display block displays left-eye image or right-eye image during the second display interval T2 of the frame. Based on the polarizing liquid crystal response curves LC_A, the second segment block operates in a mixed mode, in which a polarizing mode of the previous frame is changed to a polarizing mode of the current frame during the first polarizing interval t1 of the current frame, and operates in the first polarizing mode or the second polarizing mode during the second polarizing interval t2 of the current frame. In an exemplary embodiment, the first display interval T1 and the first polarizing interval t1 overlap each other. In an exemplary embodiment, lengths of the first display interval T1 and the first polarizing interval t1 may be substantially the same. In an alternative exemplary embodiment, the lengths of the first display interval T1 and the first polarizing interval t1 may be different from each other. In an exemplary embodiment, the lengths of the first display interval T1 and the first polarizing interval t1 may be determined based on responses of the displaying liquid crystal layer and the polarizing liquid crystal layer.

The light source driving part 700 generates a second light source driving signal LDS2 based on operating conditions of the second display block and the second segment block to selectively turn on the second light emitting block LB2 of the light source part 620 corresponding to the second segment block.

In an exemplary embodiment, the light blocking period, during which the light applied to the second display block is blocked, includes a rising interval and a falling interval of the second driving signal SGS2. In an exemplary embodiment, the light blocking period may correspond to the rising interval and the falling interval of the second driving signal SGS2. In an exemplary embodiment, an interval of the light blocking period corresponding to the rising interval and the third falling interval of the second driving signal SGS2 may be determined based on a response ratio of the polarizing liquid crystal layer and the displaying liquid crystal layer, and may be longer than the rising interval and the falling interval of the second driving signal SGS2. In an alternate exemplary embodiment, the light blocking period may include the first display interval T1 and the first polarizing interval t1.

In an exemplary embodiment, as shown in FIG. 5, the second light source driving signal LDS2 has a low level during the first display interval T1 including the first polarizing interval t1, and has a high level during the second display interval T2. The second light emitting block does not provide the second display block with light during the first display interval T1, and provides the second display block with the light during the second display interval T2.

In such an embodiment, the light is blocked to the second segment block during the rising interval and the falling interval of the second driving signal SGS2, during which a brightness difference of the second segment block may occur, such that the viewer may not perceive the brightness difference of the second segment block. In such an embodiment, the light is blocked to the second display block during the first display interval, in which the mixed image is displayed to the second display block, such that the viewer may not perceive the mixed image, and the display quality of a three-dimensional stereoscopic image is thereby substantially improved.

Similarly to the manner described above, the display driving part 300 sequentially provide third to eighth display blocks with left-eye or right-eye data signals DBS3 to DBS8, respectively, the polarized light driving part 500 sequentially provide third to eighth segment blocks with driving signals SGS3 to SGS8, respectively, and the light source driving part 700 sequentially provide third to eighth light emitting blocks with light source driving signals LDS3 to LDS8, respectively.

In such an embodiment, light is blocked by each segment block during a rising interval and a falling interval of a driving signal, during which a brightness difference of the each segment block may occur, such that viewer may not perceive the brightness difference of the first segment block. In such an embodiment, the light is blocked to each display block during a first display interval, in which the mixed image is displayed to each display block, such that the viewer may not perceive the mixed image, and the display quality of a three-dimensional stereoscopic image is thereby substantially improved.

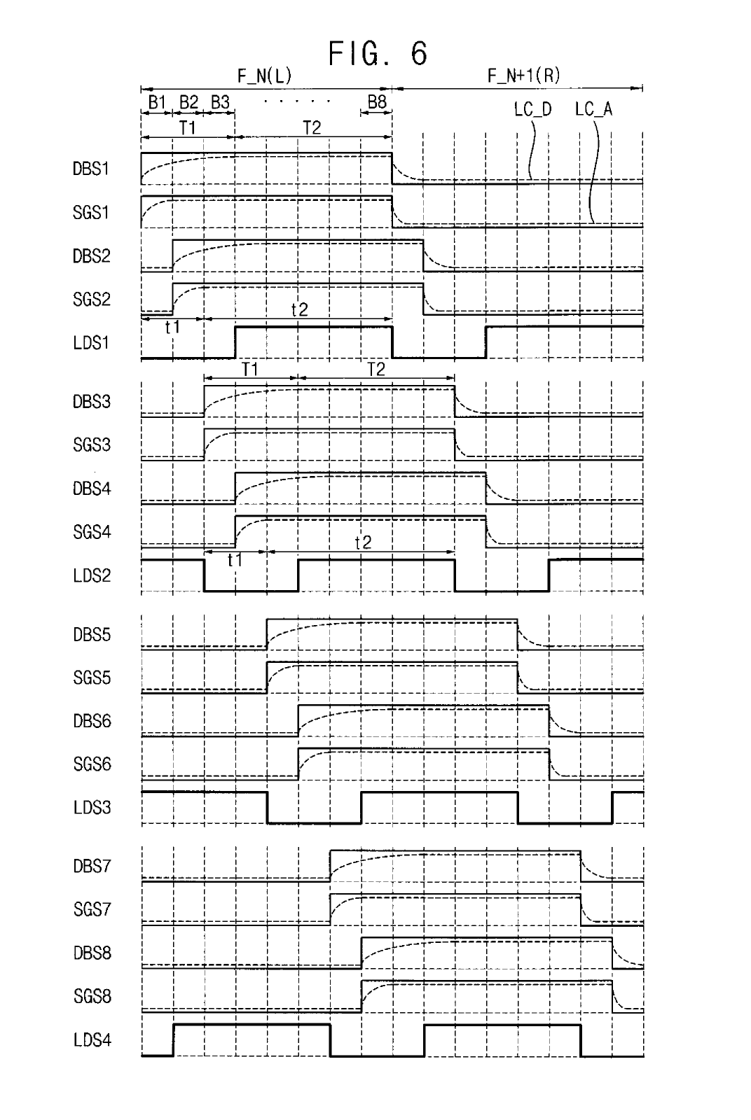

FIG. 6 is a signal timing diagram of driving signals illustrating an alternative exemplary embodiment of a method of displaying a three-dimensional stereoscopic image according to the invention.

An exemplary embodiment of a method of displaying a three-dimensional stereoscopic image may be performed using a display apparatus of FIG. 4, in which the number of light emitting blocks is less than the number of the segment block, e.g., k is less than n.

Referring to FIGS. 1, 4 and 6, an exemplary embodiment of the light source part 620 includes first to fourth light emitting blocks corresponding to the active polarized panel 400 including the first to eighth segment blocks.

The display driving part 300 provides a first display block with a left-eye data signal L during a first block interval B1 of an N-th frame F_N, and provides the first display block with a right-eye data signal R during a first block interval B1 of an N+1-th frame F_N+1(e.g., the first data signal DBS1). In an exemplary embodiment, the polarized light driving part 500 is synchronized with the display driving part 300, and the polarized light driving part 500 provides a segment electrode of the first segment block with a high-level voltage during one frame from a first block interval B1 of the N-th frame F_N, and provides the segment electrode of the first segment block with a low-level voltage during one frame from a first block interval B1 of the N+1-th frame F_N+1 (e.g., the first driving signal SGS1).

In an exemplary embodiment, the display driving part 300 provides a second display block with a left-eye data signal L during a second block interval B2 of the N-th frame F_N, and provides the second display block with a right-eye data signal R during a second block interval B2 of the N+1-th frame F_N+1(e.g., the second data signal DBS2). In such an embodiment, the polarized light driving part 50 is synchronized with the display driving part 300, the polarized light driving part 500 provides a high level voltage to a segment electrode of the second segment block during one frame from the second block interval B2 of the N-th frame F_N, and provides a low level voltage to the segment electrode of the second segment block during one frame from the second block interval B2 of the N+1-th frame F_N+1(e.g., the second driving signal SGS2).

In such an embodiment, based on the displaying liquid crystal response curves LC_D, the first and second display blocks display a mixed image, which is a transition image between an image of the previous frame to an image of the current frame, during the first display interval T1 of the current frame, and display left-eye image or right-eye image during the second display interval T2 of the current frame. Based on the polarizing liquid crystal response curves LC_A, the first and second segment blocks operate in a mixed mode, during which a polarizing mode of the previous frame is changed to a polarizing mode of the current frame, during the first polarizing interval t1 of the current frame, and operate in the first polarizing mode or the second polarizing mode during the second polarizing interval t2 of the current frame.

The first display interval T1 and the first polarizing interval t1 overlap each other. In an exemplary embodiment, lengths of the first display interval T1 and the first polarizing interval t1 may be substantially the same as each other. In an alternative exemplary embodiment, the lengths of the first display interval T1 and the first polarizing interval t1 may be different from each other. In an exemplary embodiment, the lengths of the first display interval T1 and the first polarizing interval t1 may be determined based on responses of the displaying liquid crystal layer and the polarizing liquid crystal layer.

The light source driving part 700 generates a first light source driving signal LDS1 based on operating conditions of the first and second display blocks and the first and second segment blocks to selectively turn on the first light emitting block LB1 of the light source part 620 corresponding to the first and second segment blocks.

In an exemplary embodiment, the light blocking period, during which the light applied to the first and second display blocks is blocked, includes rising intervals and falling intervals of the first and second driving signals SGS1 and SGS2. In an exemplary embodiment, the light blocking period may correspond to the rising intervals and the falling intervals of the first and second driving signals SGS1 and SGS2. In an exemplary embodiment, an interval of the light blocking period corresponding to the rising intervals and the third falling intervals of the first and second driving signals SGS1 and SGS2 may be determined based on a response ratio of the polarizing liquid crystal layer and the displaying liquid crystal layer, and may be longer than the rising intervals and the falling intervals of the first and second driving signal SGS1 and SGS2. In an alternate exemplary embodiment, the light blocking period may include the first display intervals T1 and the first polarizing intervals t1 of the first and second driving signals SGS1 and SGS2.

In an exemplary embodiment, as shown in FIG. 6, the first light source driving signal LDS1 has a low level during the first display interval T1 including the first polarizing interval t1, and has a high level during the second display interval T2. The first light emitting block does not provide the first and second display blocks with light during the first display interval T1, and provides the first and second display blocks with the light during the second display interval T2.

In such an embodiment, the light is blocked to the first and second segment block during the rising intervals and the falling intervals of the first and second driving signals SGS1 and SGS2, during which a brightness difference of the first and second segment blocks may occur, such that a viewer may not perceive the brightness difference of the first and second segment blocks. In such an embodiment, the light is blocked to the first and second display blocks during the first display interval, in which the mixed image is displayed to the first and second display blocks, such that viewer may not perceive the mixed image, and the display quality of a three-dimensional stereoscopic image is thereby substantially improved.

The display driving part 300 provides a third display block with a left-eye data signal L during a third block interval B3 of the N-th frame F_N, and provides the third display block with a right-eye data signal R during a third block interval B3 of the N+1-th frame F_N+1(e.g., the third data signal DBS3). In an exemplary embodiment, the polarized light driving part 500 is synchronized with the display driving part 300, and the polarized light driving part 500 provides a high level voltage to a segment electrode of a third segment block during one frame from the third block interval B3 of the N-th frame F_N, and provides a low level voltage to the segment electrode of the third segment block during one frame from the third block interval B3 of the N+1-th frame F_N+1(e.g., the third driving signal SGS3).

In an exemplary embodiment, the display driving part 300 provides a fourth display block with a left-eye data signal L during a fourth block interval B4 of the N-th frame F_N, and provides the fourth display block with a right-eye data signal R during a fourth block interval B4 of the N+1-th frame F_N+1(e.g., the fourth data signal DBS4). In an exemplary embodiment, the polarized light driving part 500 is synchronized with the display driving part 300, and the polarized light driving part 500 provides a high level voltage to a segment electrode of a fourth segment block during one frame from the fourth block interval B4 of the N-th frame F_N, and provides a low level voltage to the segment electrode of the fourth segment block during one frame from the fourth block interval B4 of the N+1-th frame F_N+1(e.g., the fourth driving signal SGS4).

In such an embodiment, based on the displaying liquid crystal response curves LC_D, the third and fourth display blocks display a mixed image, which is a transition image between an image of the previous frame and an image of the current frame, during the first display interval T1 of the current frame, and display left-eye image or right-eye image during the second display interval T2 of the current frame. Based on the polarizing liquid crystal response curves LC_A, the third and fourth segment blocks operate in a mixed mode, in which a polarizing mode of the previous frame is changed to a polarizing mode of the current frame, during the first polarizing interval t1 of the frame, and operate in the first polarizing mode or the second polarizing mode during the second polarizing interval t2 of the current frame.

The light source driving part 700 generates a second light source driving signal LDS2 based on operating conditions of the third and fourth display blocks and the third and fourth segment blocks to selectively turn on the second light emitting block LB2 of the light source part 620 corresponding to the third and fourth segment blocks.

In an exemplary embodiment, the light blocking period, the light applied to the third and fourth display blocks is blocked, includes rising intervals and falling intervals of the third and fourth driving signals SGS3 and SGS4. In an exemplary embodiment, the light blocking period may correspond to the rising intervals and the falling intervals of the third and fourth driving signals SGS3 and SGS4. In an exemplary embodiment, an interval of the light blocking period corresponding to the rising intervals and the third falling intervals of the third and fourth driving signals SGS3 and SGS4 may be determined based on a response ratio of the polarizing liquid crystal layer and the displaying liquid crystal layer, and may be longer than the rising intervals and the falling intervals of the third and fourth driving signals SGS3 and SGS4. In an alternate exemplary embodiment, the light blocking period may include the first display intervals T1 and the first polarizing intervals t1 of the third and fourth driving signals SGS3 and SGS4.

In an exemplary embodiment, as shown in FIG. 6, the second light source driving signal LDS2 has a low level during the first display interval T1 including the first polarizing interval t1, and has a high level during the second display interval T2. The second light emitting block does not provide the third and fourth display blocks with light during the first display interval T1, and provides the third and fourth display blocks with the light during the second display interval T2.

In such an embodiment, the light is blocked to the third and fourth segment block during the rising intervals and the falling intervals of the third and fourth driving signals SGS3 and SGS4, during which a brightness difference of the third and fourth segment blocks may occur, such that a viewer may not perceive the brightness difference of the third and fourth segment blocks. In such an embodiment, the light is blocked to the third and fourth display blocks during the first display interval, in which the mixed image is displayed to the third and fourth display blocks, such that viewer may not perceive the mixed image, and the display quality of a three-dimensional stereoscopic image is thereby substantially improved.

Similarly to the manner described above, the display driving part 300 sequentially provide fifth to eighth display blocks with left-eye or right-eye data signals DBS5 to DBS8, respectively, the polarized light driving part 500 sequentially provide fifth to eighth segment blocks with driving signals SGS5 to SGS8, respectively, and the light source driving part 700 sequentially provide fifth to eighth light emitting blocks with light source driving signals LDS5 to LDS8, respectively.

In an exemplary embodiment, light is blocked to each segment block during a rising interval and a falling interval of a driving signal, during which a brightness difference of the each segment block may occur, such that a viewer may not perceive the brightness difference of the first segment block. In such an embodiment, light is blocked to each display block during a first display interval, in which the mixed image is displayed to each display block, such that the viewer may not perceive the mixed image, and the display quality of a three-dimensional stereoscopic image is thereby substantially improved. In an exemplary embodiment, the number of light emitting blocks is less than the number of the segment block, and the manufacturing cost is thereby decreased.

A following Table 1 shows brightness difference of segment blocks of a comparison embodiment and exemplary embodiments of the invention.

TABLE 1
Brightness difference of segment blocks (Segment 8ea)

| | | | A first | A second |
|---|---|---|---|---|
| | | | exemplary | exemplary |
| | | comparison | embodiment | embodiment |
| | | embodiment | (blinking) | (scanning) |
| Light emitting interval | | 100% | 50% | 50% |
| LEFT | WB | 1.05 cd/m² | 0.42 cd/m² | 0.20 cd/m² |
| | BW | 1.14 cd/m² | 0.38 cd/m² | 0.01 cd/m² |
| RIGHT | WB | 1.09 cd/m² | 0.46 cd/m² | 0.19 cd/m² |
| | BW | 0.96 cd/m² | 0.31 cd/m² | 0.01 cd/m² |

In Table 1, light is generated during 100% of one frame in the comparison embodiment. In the first exemplary embodiment, light is generated during 50% of one frame, and the light is blocked the rising interval and the falling interval of the driving signal corresponding to each of the segment blocks, as shown in FIG. 4. In the second exemplary embodiment, light is generated during 50% of one frame, and the light emitting blocks are sequentially emitted along the scanning direction, as shown in FIGS. 5 and 6.

Referring to a left-eye image LEFT of the comparison embodiment, when the left-eye image is changed from a white image to a black image WB, a brightness difference of segment blocks is about 1.05 candelas per square meter (cd/m²). When the left-eye image is changed from a black image to a white image BW, a brightness difference of segment blocks is about 1.14 cd/m². Referring to a right-eye image RIGHT of the comparison embodiment, when the right-eye image is changed from a white image to a black image WB, a brightness difference of segment blocks is about 1.09 cd/m². When the right-eye image is changed from a black image to a white image BW, a brightness difference of segment blocks is about 0.96 cd/m².

Referring to a left-eye image LEFT of the first exemplary embodiment, when the left-eye image is changed from a white image to a black image WB, a brightness difference of segment block is about 0.42 cd/m². When the left-eye image is changed from a black image to a white image BW, a brightness difference of segment block is about 0.38 cd/m². Referring to a right-eye image RIGHT of the first exemplary embodiment, when the right-eye image is changed from a white image to a black image WB, a brightness difference of segment block is about 0.46 cd/m². When the right-eye image is changed from a black image to a white image BW, a brightness difference of segment block is about 0.31 cd/m².

Referring to a left-eye image LEFT of the second exemplary embodiment, when the left-eye image is changed from a white image to a black image WB, a brightness difference of segment block is about 0.20 cd/m². When the left-eye image is changed from a black image to a white image BW, a brightness difference of segment block is about 0.01 cd/m². Referring to a right-eye image RIGHT of the second exemplary embodiment, when the right-eye image is changed from a white image to a black image WB, a brightness difference of segment block is about 0.19 cd/m². When the right-eye image is changed from a black image to a white image BW, a brightness difference of segment block is about 0.01 cd/m².

As shown in Table 1, brightness differences of segment blocks in the first and second exemplary embodiments is less than the brightness differences in the comparison embodiment.

A following Table 2 shows a brightness ratio of three-dimensional stereoscopic image to a two-dimensional image in a comparison embodiment and exemplary embodiments.

TABLE 2
a ratio of a brightness of 3D to a brightness of 2D

| | Comparison | Exemplary | | | |
|---|---|---|---|---|---|
| | embodiment | embodiments | | | |
| Boosting light | 125% | 100% | | 113% | 125% |
| Light emitting interval | 32% | 50% | 30% | 50% | 30% |
| Efficiency of glasses | 60% | 80% | | | |
| Brightness ratio | 12% | 20% | 12% | 22.6% | 15% |

Referring to Table 2, the comparison embodiment is a display apparatus of a liquid crystal shutter glasses type. In the comparison embodiment of the display apparatus, when a light source part generates an about 125% boosting light during an about 32% of a light emitting interval, a brightness ratio of the three-dimensional stereoscopic image to the two-dimensional image is about 12%.

In Table 2, the exemplary embodiments are a display apparatus of a polarized shutter glasses type using an active polarized panel. In the exemplary embodiments of the display apparatus, when a light source part generates an about 100% boosting light during an about 50% of light emitting interval, a brightness ratio of the three-dimensional stereoscopic image to the two-dimensional image is about 20%. In the exemplary embodiments, when a light source part generates an about 100% boosting light during an about 30% of light emitting interval, a brightness ratio of the three-dimensional stereoscopic image to the two-dimensional image is about 12%.

In the exemplary embodiments of the display apparatus, when a light source part generates an about 113% boosting light during an about 50% of light emitting interval, a brightness ratio of the three-dimensional stereoscopic image to the two-dimensional image is about 22.6%. In the exemplary embodiments, when a light source part generates an about 125% boosting light during an about 30% of light emitting interval, a brightness ratio of the three-dimensional stereoscopic image to the two-dimensional image is about 15%.

As shown in Table 2, a brightness ratio of the three-dimensional stereoscopic image to the two-dimensional image of the exemplary embodiment is greater than a brightness ratio of the three-dimensional stereoscopic image to the two-dimensional image of the comparison embodiment.

According to the exemplary embodiments, light emitting source part is controlled corresponding to a level changing interval of a driving signal corresponding to a segment block in a first polarizing mode and a second polarizing mode, such that a brightness difference perceived in the segment block is substantially improved, and a brightness ratio of the three-dimensional stereoscopic image to the two-dimensional image is substantially improved.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of displaying a three-dimensional stereoscopic image, the method comprising:
providing a display panel with a data signal including a left-eye data signal and a right-eye data signal;
sequentially providing each of a plurality of segment blocks of an active polarized panel with a driving signal including a high level and a low level, wherein the active polarized panel emits first polarized light in a first polarizing mode of the driving signal based on the data signal, and the active polarized panel emits second polarized light in a second polarizing mode of the driving signal based on the data signal; and
selectively providing the display panel with light based on a level changing interval of the driving signal, during which a level of the driving signal is changed.

2. The method of claim 1, wherein
a first light blocking period, during which the light to the display panel is blocked, comprises a rising interval and a falling interval,
the level of the driving signal is changed from the low level into the high level during the rising interval of the first light blocking period, and
the level of the driving signal is changed from the high level into the low level during the falling interval of the first light blocking period.

3. The method of claim 2, wherein
the active polarized panel comprises a polarizing liquid crystal layer, and
the first light blocking period of the display panel is preset based on a response rate of the polarizing liquid crystal layer.

4. The method of claim 2, wherein
the first light blocking period comprises a mixed interval, and
the first and second polarizing modes of the driving signal are changed from one to the other during the mixed interval.

5. The method of claim 2, wherein the selectively providing the display panel with the light comprises:
sequentially providing a plurality of display blocks of the display panel with the light from a plurality of light emitting blocks, wherein the display blocks correspond to the segment blocks; and
blocking the light from each of the light emitting blocks to a corresponding display block of based on a change of the level of the driving signal applied to a corresponding segment block of the corresponding display block.

6. The method of claim 5, wherein the light emitting blocks are in one-to-one correspondence with the segment blocks.

7. The method of claim 5, wherein each of the light emitting blocks corresponds to at least two adjacent segment blocks of the segment blocks.

8. The method of claim 5, wherein
a second light blocking period, during which the light from at least one of the display blocks is blocked, comprises a rising interval and a falling interval,
the level of the driving signal applied to the segment blocks corresponding to the at least one of the display blocks is changed from the low level into the high level during the rising interval of the second light blocking period, and
the level of the driving signal applied to the segment blocks corresponding to the at least one of the display blocks is changed from the high level into the low level during the falling interval of the second light blocking period.

9. The method of claim 8, wherein
the display panel comprises a displaying liquid crystal layer,
the active polarized panel comprises a polarizing liquid crystal layer, and
the second light blocking period of the display block is preset based on response rates of the displaying liquid crystal layer and the polarizing liquid crystal layer.

10. The method of claim 8, wherein
the second light blocking period of the driving signal corresponds to a first mixed interval and a second mixed interval,
the left-eye data and the right-eye data are changed from one to the other during the first mixed interval, and
the first and second polarizing modes are changed from one to the other during a second mixed interval.

11. A display apparatus, comprising:
a display driving part which provides a display panel with a data signal including a left-eye data signal and a right-eye data signal;
an active polarized panel comprising a plurality of segment blocks, wherein the active polarized panel emits first polarized light in a first polarizing mode and emits second polarized light in a second polarizing mode;
a polarized light driving part which sequentially provides each of the segment blocks with a driving signal, wherein a level of the driving signal includes a high level and a low level, the active polarized panel is in the first polarizing mode based on the high level of the driving signal in the first polarizing mode, the active polarized panel is in the second polarizing mode based on the low level of the driving signal; and
a light source part which selectively provides the display panel with light based on a change of the level of the driving signal.

12. The display apparatus of claim 11, wherein
the light source part blocks the light to the display panel based on a rising interval and a falling interval,
the level of the driving signal is changed from the low level into the high level during the rising interval, and
the level of the driving signal is changed from the high level into the low level during the falling interval.

13. The display apparatus of claim 12, wherein
the active polarized panel comprises a polarizing liquid crystal layer, and
a first light blocking period, during which the light to the display panel is blocked, is preset based on a response rate of the polarizing liquid crystal layer.

14. The display apparatus of claim 13, wherein
the first light blocking period comprises a mixed interval, and
the first and second polarizing modes of the segment blocks are changed from one to the other during the mixed interval.

15. The display apparatus of claim 12, wherein
the light source part comprises a plurality of light emitting blocks which sequentially provides a plurality of display blocks of the display panel with the light,
the display blocks correspond to the segment blocks, and
the light to each of the display blocks is blocked based on the change of the level of the driving signal applied to a corresponding segment block thereof.

16. The display apparatus of claim 15, wherein the light emitting blocks are in one-to-one correspondence with the segment blocks.

17. The display apparatus of claim 15, wherein each of the light emitting blocks corresponds to at least two adjacent segment blocks of the segment blocks.

18. The display apparatus of claim 15, wherein
a second light blocking period, during which the light to at least one of the display blocks, is blocked comprises a rising interval and a falling interval,
the level of the driving signal applied to the segment blocks corresponding to the at least one of the display blocks is changed from the low level into the high level during the rising interval of the second light blocking period, and
the level of the driving signal applied to the segment blocks corresponding to the at least one of the display blocks is changed from the high level into the low level during the falling interval of the second light blocking period.

19. The display apparatus of claim 18, wherein
the display panel comprises a displaying liquid crystal layer,
the active polarized panel comprises a polarizing liquid crystal layer, and
the second light blocking period of the display block is preset based on response rates of the displaying liquid crystal layer and the polarizing liquid crystal layer.

20. The display apparatus of claim 18, wherein
the second light blocking period comprises a first mixed interval and a second mixed interval,
the left-eye data and right-eye data are changed from one to the other during the first mixed interval, and
the first and second polarizing modes are changed from one to the other during a second mixed interval.
